(19) United States
(12) Patent Application Publication
(10) Pub. No.: US 2025/0383613 A1
(43) Pub. Date: Dec. 18, 2025

(54) TONER FOR THERMAL TRANSFER PRINT SHEET, METHOD OF MANUFACTURING THERMAL TRANSFER PRINT SHEET, PRINTING METHOD, AND STORAGE CONTAINER FOR TONER FOR THERMAL TRANSFER PRINT SHEET

(71) Applicants: Akihiro Kaneko, Kanagawa (JP); Kohtaroh Ogino, Kanagawa (JP); Hiroshi Yamada, Kanagawa (JP); Kaede Masuko, Kanagawa (JP)

(72) Inventors: Akihiro Kaneko, Kanagawa (JP); Kohtaroh Ogino, Kanagawa (JP); Hiroshi Yamada, Kanagawa (JP); Kaede Masuko, Kanagawa (JP)

(73) Assignee: Ricoh Company, Ltd., Tokyo (JP)

(21) Appl. No.: 19/222,260

(22) Filed: May 29, 2025

(30) Foreign Application Priority Data
Jun. 17, 2024 (JP) 2024-097515

(51) Int. Cl. G03G 9/09; B41M 5/025; G03G 15/00

(52) U.S. Cl. CPC G03G 9/0906; B41M 5/0256; G03G 15/6591

(57) ABSTRACT

A toner for a thermal transfer print sheet contains a polyester resin having an acid value of at least 25 mgKOH/g, a coloring pigment, a release agent, and a curing agent.

### CROSS-REFERENCE TO RELATED APPLICATIONS

This patent application is based on and claims priority pursuant to 35 U.S.C. § 119 to Japanese Patent Application No. 2024-097515, filed on Jun. 17, 2024, in the Japan Patent Office, the entire disclosure of which is hereby incorporated by reference herein.

### BACKGROUND

### Technical Field

The present disclosure is related to a toner for a thermal transfer print sheet, a method of manufacturing a thermal transfer print sheet, a printing method, and a storage container for the toner for a thermal transfer print sheet.

### Description of the Related Art

With the widespread adoption of electrophotographic color image forming apparatuses, their applications have also expanded in a diverse range of fields. For example, in addition to traditional paper printing, there is a growing demand for printing on fabrics, ceramics, tiles, and other materials.

In recent years, from the perspective of enabling electrophotographic printing on a wide variety of materials, image forming methods using thermal transfer sheets have been widely employed.

### SUMMARY

According to embodiments of the present disclosure, a toner for a thermal transfer print sheet is provided which contains a polyester resin having an acid value of at least 25 mgKOH/g, a coloring pigment, a release agent, and a curing agent.

As another aspect of embodiments of the present disclosure, a method of manufacturing a thermal transfer print sheet which includes forming an image on a substrate with a toner containing a polyester resin having an acid value of at least 25 mgKOH/g, a coloring pigment, a release agent, and a curing agent.

As another aspect of embodiments of the present disclosure, a printing method is provided which includes forming an image on a substrate with a toner that contains a polyester resin having an acid value of at least 25 mgKOH/g, a coloring pigment, a release agent, and a curing agent, and thermally transferring the image to a transfer medium.

As another aspect of embodiments of the present disclosure, a storage container for the toner mentioned above for a thermal transfer print sheet is provided.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a storage container for the toner for a thermal transfer print sheet;

FIG. 2 is a diagram illustrating a schematic configuration of the apparatus for manufacturing thermal transfer print sheets relating to the present disclosure; and

FIG. 3 is a diagram illustrating a storage container for the toner for a thermal transfer print sheet.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a toner for thermal transfer print sheets is provided which minimizes image peeling after transfer.

In the method described in Unexamined Japanese Patent Application Publication No. H9-295453, although an image formed by electrophotography can be transferred onto a target object in a high-quality state, it involves a problem in that the printed image could not be maintained in good condition over a long period. For example, if the target object is a ceramic product such as a tile, the ceramic product is constantly exposed to external contact, making the image prone to deterioration (such as peeling) and highlighting the need for improvement in maintaining image quality.

The toner for thermal transfer print sheets of the present disclosure can effectively resolve various concerns associated with typical technologies. More specifically, it can minimize image peeling after transfer.

The present disclosure is described in detail below.

### Toner for Thermal Transfer Print Sheets

The toner for thermal transfer print sheets in the present disclosure contains a polyester resin with an acid value of at least 25 mgKOH/g, a coloring pigment, a release agent, and a curing agent. Additionally, other optional components may be included.

In the present specification, the “toner for thermal transfer print sheets” may simply be referred to as “toner.”

The toner of the present disclosure is thermally pressed onto the transfer material, whereupon the curing agent contained in the toner reacts, and the polyester resin with an acid value of at least 25 mgKOH/g cures, thereby improving the strength of the resulting image. As a result, the obtained image can be maintained in good condition for a long period, and image deterioration (such as peeling) can be minimized.

### Polyester Resin With Acid Value of at Least 25 mgKOH

As the polyester resin with an acid value of at least 25 mgKOH/g, any resin that has an acid value of at least 25 mgKOH/g and functions as a binder resin may be used without particular limitation, and it can be appropriately selected according to a particular application. The inclusion of a polyester resin with an acid value of at least 25 mgKOH/g in the toner of the present disclosure improves low temperature fixability and enhances environmental safety by reducing volatile organic compounds (VOCs) derived from residual monomers.

Additionally, if the acid value of the polyester resin is at least 25 mgKOH/g, the carboxyl-terminated groups of the polyester resin react with the curing agent, resulting in an image with excellent strength, thereby preventing image deterioration (such as peeling).

As the polyester resin with an acid value of at least 25 mgKOH/g, reaction products obtained by polycondensation of known alcohols and known acids can be used.

There are no restrictions on the alcohol and it can be suitably selected to suit a particular application.

Specific examples of alcohols include, but are not limited to, diols such as polyethylene glycol, diethylene glycol, triethylene glycol, 1,2-propylene glycol, 1,3-propylene glycol, diols, 1,4-propylene glycol, neopentyl glycol, neopentyl glycol, and 1, 4-butene diol; etherified bisphenols such as 1,4-bis(hydoroxymethyl)cyclohexane, bisphenol A, hydrogenated bisphenol A, polyoxyethyed bisphenol A, and polyoxypropylened bisphenol A; diol units in which these are substituted by saturated or unsaturated hydrocarbon groups having 3 to 22 carbon atoms; other diol units; tri- or higher alcohol monomers such as sorbitol, 1,2,3,6-hexanetetrol, 1,4-sorbitan, pentaerythritol, dipentaerythritol, tripentaerythritol, saccharose, 1,2,4-butane triol, 1,2,5-pentane triol, glycerol, 2-methylpropane triol, 2-methyl-1,2,4-butane triol, trimethylol ethane, trimethylol propane, 1,3,5-trihydroxy benzene.

There is no specific limit to the acid and it can be suitably selected to suit to a particular application; carboxylic acids are usable.

Specific examples of carboxylic acids include, but are not limited to, monocarboxylic acids such as palmitic acid, stearic acid, and oleic acid; divalent organic acids such as maleic acid, fumaric acid, mesaconic acid, citraconic acid, terephthalic acid, cyclohexane dicarboxylic acid, succinic acid, adipic acid, sebatic acid, and malonic acid, and divalent organic acid monomers in which these are substituted by saturated or unsaturated hydrocarbon groups having 3 to 22 carbon atoms; anhydrides of these acids; dimers of a lower alkyl ester and linoleic acid; 1,2,4-benzene tricarboxylic acid, 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylene carboxypropane, tetra(methylenecarboxyl)methane, 1,2,7,8-octane tetracarboxylic acid, Empol® trimer acid, and polycarboxylic acid monomer of anhydrides of these aids.

The weight average particle diameter Mw of the polyester resin with an acid value of at least 25 mgKOH/g is not particularly limited and it can be suitably selected to suit to a particular application. It is preferably from 9,500 to 55,000.

The number average particle diameter Mn of the polyester resin with an acid value of at least 25 mgKOH/g is not particularly limited and it can be suitably selected to suit to a particular application. It is preferably from 1,800 to 4,000.

The method of measuring the weight-average molecular weight Mw and number average molecular weight Mn of the polyester resin with an acid value of at least 25 mgKOH/g is not particularly limited and can be appropriately selected according to a particular application. For example, it can be measured using gel permeation chromatography (GPC).

The polyester resin with an acid value of at least 25 mgKOH/g contained in the toner of the present disclosure may be used alone if it has an acid value of at least 25 mgKOH/g, or two or more polyester resins with different acid values may be used in combination.

The method of measuring the acid value of the polyester resin with an acid value of at least 25 mgKOH/g is not particularly limited and can be appropriately selected according to a particular application. For example, it can be determined by the following method in accordance with JIS K-0070 (Test methods for acid value, saponification value, ester value, iodine value, hydroxyl value and unsaponifiable matter of chemical products).

(1) The sample is used after removing additives other than the binder resin (polymer component) in advance, or the acid value and content of the binder resin and the components other than the cross-linked binder resin are determined beforehand. A pulverized sample of 0.5 g to 2.0 g is accurately weighed, and the weight of the polymer component is defined as W (g). For example, to measure the acid value of the binder resin based on the toner, the acid value and content of coloring pigments, magnetic substances, and other components are separately measured in advance, and the acid value of the binder resin is determined through calculation.

(2) The sample is placed in 300 mL beaker and a 150 mL of a liquid mixture of toluene/ethanol (volume ratio at 4:1) is added thereto to dissolve the sample.

(3) The sample is titrated using a potentiometric titration measuring device with a 0.1 mol/L KOH ethanol solution.

(4) The amount of KOH solution used in this titration is denoted as S (mL). Simultaneously, a blank measurement is performed, and the amount of KOH solution used in the blank measurement is denoted as B (mL). The acid value is then calculated using the following Relationship 1. f means the factor of KOH.

$$Acid value ( mg KOH / g ) = \{ ( S - B ) \times f \times 5.61 \} / W \qquad Relationship 1$$

The glass transition temperature (Tg) of the polyester resin with an acid value of at least 25 mgKOH/g is not particularly limited and can be appropriately selected according to a particular application. However, from the perspective of excellent fixability and toner storage stability, it is preferably between 50 degrees Celsius and 70 degrees Celsius.

The glass transition temperature can be measured by any method that suits a particular application. One way of measuring is as follows.

The glass transition temperature Tg is determined using a differential scanning calorimeter (DSC 210, available from Seiko Instruments Inc.). Specifically, a sample weighing between 0.01 g to 0.02 g is loaded into an aluminum pan. The sample undergoes a heating cycle from room temperature to 200 degrees Celsius, followed by cooling to 20 degrees Celsius at a rate of −10 degrees Celsius per minute, and then reheating at a rate of 10 degrees Celsius per minute.

The Tg is identified as the intersection point between the extended baseline, which should not exceed the temperature of the endothermic peak, and the tangent showing the steepest slope of the rising part of the peak to its apex.

The polyester resin with an acid value of at least 25 mgKOH/g can be synthesized or procured.

As a commercially available polyester resin with an acid value of at least 25 mgKOH/g, one specific example is RN-290 (Mw: 52,000, Mn: 2,000, acid value: 28 mgKOH/g, available from Kao Corporation.)

### Coloring Pigment

The coloring pigment is not particularly limited and coloring pigments commonly used for toner can be appropriately selected and used.

As a black coloring pigment, one of the examples is carbon black. If this black coloring pigment is used in toner, carbon black may be mixed with copper phthalocyanine or other substances to adjust hue and brightness. These black coloring pigments may be used alone or in combination with two or more types.

As a cyan coloring pigment, examples include copper phthalocyanine, such as Pigment Blue 15:3, or a mixture of Pigment Blue 15:3 with aluminum phthalocyanine. These cyan coloring pigments may be used alone or in combination with two or more types.

As magenta coloring pigments, specific examples include, but are not limited to, Pigment Red 53:1, Pigment Red 81, Pigment Red 122, and Pigment Red 269. These magenta coloring pigments may be used alone or in combination with two or more types.

As yellow coloring pigments, specific examples include, but are not limited to, Pigment Yellow 74, Pigment Yellow 155, Pigment Yellow 180, and Pigment Yellow 185. These yellow coloring pigments may be used alone or in combination with two or more types. Among these, from the perspective of chroma and storage stability, Pigment Yellow 185 and a mixture of Pigment Yellow 185 with Pigment Yellow 74 are preferred.

As white coloring pigments, specific examples include, but are not limited to, titanium dioxide surface-treated with silicon, zirconia, aluminum, polyols, and other substances. These white coloring pigments may be used alone or in combination with two or more types.

As a green coloring pigment, one specific example is Pigment Green 7.

As blue coloring pigments, specific examples include, but are not limited to, Pigment Blue 15:1 and Pigment Violet 23. These blue coloring pigments may be used alone or in combination with two or more types.

The content of the coloring pigment is not particularly limited and can be appropriately selected according to a particular application. From the perspective of exhibiting high opacity during image formation, it is preferably between 3 percent by mass and 50 percent by mass of the entire of the toner.

The average particle diameter of the coloring pigment is not particularly limited and can be appropriately selected according to a particular application. However, from the viewpoint of excellent dispersibility in the toner and high opacity during image formation, it is preferably between 30 nm and 1 μm.

There are no particular restrictions on the measurement method for the average particle size of coloring pigments, and an appropriate method can be selected according to a particular application. For example, one such method is observation using a transmission electron microscope (TEM).

The coloring pigment is preferably dispersed within the toner.

The dispersion state of the coloring pigment in the toner can be confirmed, for example, by embedding the toner particles in a two-component epoxy resin, then slicing them into thin sections using an ULTRACUT-S ultramicrotome (available from Leica Microsystems), and observing the cross-section with a JEM-2100 transmission electron microscope (available from JEOL Ltd.).

These coloring pigments can be synthesized or procured.

One such product is C-44 (available from Mitsubishi Chemical Corporation).

### Release Agent

The release agent is not particularly limited and can be suitably selected to suit to a particular application. It is preferably monoester wax. Monoester waxes have limited compatibility with common binder resins, causing them to migrate to the surface during fixing. This migration enhances releasability, resulting in improved gloss and excellent low-temperature fixability.

The proportion of the release agent is not particularly limited and can be suitably selected to suit to a particular application. The number of parts of the release agent is preferably from 3 to 10 parts by mass and more preferably from 4 to 6 parts by mass to 100 parts of the toner.

Provided that the release agent content is at least 3 parts by mass per 100 parts of toner, it readily migrates to the image surface during fixing. This migration enhances releasability, resulting in improved gloss, better low-temperature fixability, and increased high-temperature offset resistance.

If the content of the release agent is at most 10 parts by mass per 100 parts by mass of the toner, the amount of the release agent precipitated on the toner surface is minimized, improving the storage stability of the toner and enhancing its filming properties on latent electrostatic image bearers and other surfaces.

If monoester wax is used as the release agent, it is preferable that the monoester wax be a synthetic ester wax.

Examples of synthetic ester waxes include monoester waxes synthesized from long-chain linear saturated fatty acids and long-chain linear saturated alcohols.

The long-chain linear saturated aliphatic acid is represented by CₙH₂ₙ₊₁COOH. “n” is preferably from about 5 to about 28.

Specific examples of the long-chain linear saturated aliphatic acids include, but are not limited to, capric acid, undecylic acid, lauric acid, tridecylic acid, myristic acid, pentadecylic acid, palmitic acid, hepta decanic acid, tetradecanic acid, stearic acid, nonadecanic acid, aramonic acid, behenic acid, lignoceric acid, cerotic acid, heptacosanoic acid, montanic acid, and melissic acid.

The long-chain linear saturated alcohol is represented by CₙH₂ₙ₊₁OH. “n” is preferably from about 5 to about 28.

Specific examples of the long-chain linear saturated alcohols include, but are not limited to, amyl alcohol, hexyl alcohol, heptyl alcohol, octyl alcohol, capryl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, eicosyl alcohol, ceryl alcohol, and heptadecanol.

These may have substituted groups such as lower alkyl groups, amino groups, and halogen atoms.

### Curing Agent

As long as the curing agent can react with a polyester resin having an acid value of at least 25 mg KOH/g, there are no particular restrictions on its selection, and it can be appropriately chosen according to a particular application. However, it is preferable that the curing agent contains a primid curing type material. If the curing agent contains a primid curing type material, the resin can be cured through a crosslinking reaction at a low temperature of at most 160 degrees Celsius, thereby minimizing image degradation (peeling).

There are no particular restrictions on the primid curing type material, and it can be appropriately selected according to a particular application. From the perspectives of reaction byproducts and material toxicity, β-hydroxyalkylamide is preferred.

There are no particular restrictions on the content of the curing agent, and it can be appropriately set according to the amount of reactive carboxyl groups. A preferable range is from 2 percent by mass to 25 percent by mass relative to the entire of the toner.

There are no particular restrictions on the measurement method for the content of the curing agent, and it can be appropriately selected according to a particular application. For example, the content can be measured using the following method:

The derivatization pyrolysis method using a GC/MS system is employed. The sample is dissolved in THF and adjusted to 10 mg/mL A 25 percent methanol solution of tetramethylammonium hydroxide is used as the derivatizing reagent for the measurement. The ester bonds in the sample are cleaved and methylated, and the spectral intensity of the methylated ester compounds is obtained.

By applying the above process to toner before and after curing and measuring the spectral intensity of methyl compounds, the presence and content of the curing agent can be determined based on the changes in the amount of ester bonds due to primid curing of β-hydroxyalkylamide.

These curing agents can be synthesized or procured.

One such specific example of the curing agent product is Primid XL-552 (available from EMS-CHEMIE (Japan) Ltd.).

### Other Optional Components

The other optional components are not particularly limited and can be selected to suit a suitable application. Examples thereof are binder resins, wax dispersants, and additives.

### Other Binder Resin

The other binder resins are not particularly limited and may be appropriately selected to suit a suitable application. Examples include, but are not limited to, epoxy resins, polyurethane resins, polyamide resins, and styrene-acrylic copolymers.

These can be used alone or in combination.

### Trivalent or Higher Metal Salt

Preferably, the toner of the present disclosure contains a trivalent or higher metal salt. If the toner contains the metal salt, a crosslinking reaction progresses during fixing with the acidic groups of the polyester resin having an acid value of at least 25 mg KOH/g, forming a weak three-dimensional crosslinking structure. As a result, high-temperature offset resistance can be achieved while low-temperature fixability is maintained.

There are no particular restrictions on trivalent or higher metal salts, and they can be appropriately selected according to a particular application. Examples include, but are not limited to, metal salts of salicylic acid derivatives and metal acetylacetonates. These can be used alone or in combination.

As for the metal component, any polyvalent metal ion of trivalent or higher valency can be selected as appropriate, with no particular restrictions. Examples include, but are not limited to, iron, zirconium, aluminum, titanium, and nickel.

Among these, trivalent or higher salicylic acid metal compounds are preferred.

The proportion of the trivalent or higher metal salt is not particularly limited and can be suitably selected to suit a particular application. The number of parts of the metal salt is preferably from 0.3 to 2 parts by mass and more preferably from 0.4 to 1 part by mass to 100 parts of the toner mentioned above.

If the content of the trivalent or higher metal salt is at least 0.3 parts by mass per 100 parts by mass of the toner, high-temperature offset resistance is improved.

If the content of the trivalent or higher metal salt is at most 2 parts by mass per 100 parts by mass of the toner, glossiness and low-temperature fixability are enhanced.

### Wax Dispersant

The toner of the present disclosure preferably contains wax dispersant. Dispersion effect is obtained by containing a wax dispersant and the toner is stably stored irrespective of the manufacturing method thereof. In addition, due to the dispersion effect of the wax, the wax diameter decreases, thereby minimizing filming phenomenon to a photoconductor and an image bearer.

As the wax dispersant, a copolymer composition containing at least styrene, butyl acrylate, and acrylonitrile as monomers or an adduct of such a copolymer composition with polyethylene is more preferable.

Styrene resins generally exhibit higher compatibility with typical waxes than polyester resins with an acid value of at least 25 mg KOH/g, thereby allowing finer wax dispersion. Additionally, owing to its weaker internal cohesion, styrene resin exhibits superior grindability compared to polyester resin with an acid value of at least 25 mg KOH/g. As a result, even when the wax dispersion state is the same, the probability that the interface between the wax and the resin becomes the fracture surface is low like polyester resin with an acid value of at least 25 mg KOH/g. Therefore, the amount of wax present on the toner particle surface decreases, thereby improving the storage stability of the toner.

Since the polyester resin with an acid value of at least 25 mg KOH/g and the styrene resin contained in the toner of the present disclosure are incompatible, they tend to lower image gloss. Therefore, it is preferable to use a styrene resin with an SP value close to that of the polyester resin with an acid value of at least 25 mg KOH/g.

One such example of styrene resins with an SP value close to that of polyester resin with an acid value of at least 25 mg KOH/g is butyl acrylate. If the acrylic component is butyl acrylate, it is easier to achieve thermal properties similar to polyester, which does not significantly disrupt the low temperature fixability and internal cohesion of the polyester resin with an acid value of at least 25 mg KOH/g.

There are no particular restrictions on the content of the wax dispersant, and it can be appropriately selected according to a particular application. It is preferable that the content be at most 7 parts by mass per 100 parts by mass of the toner.

If the wax dispersant content is at most 7 parts by mass per 100 parts by mass of the toner, the amount of incompatible components relative to the polyester resin with an acid value of at least 25 mg KOH/g can be reduced, resulting in improved gloss. Additionally, since wax dispersion is improved, anti-filming properties, low temperature fixability, and hot offset resistance are also enhanced.

### Additive

There are no particular restrictions on the additives, and they can be appropriately selected according to a particular application. Examples include, but are not limited to, abrasives, flowability enhancers, anti-agglomeration agents, conductivity enhancers, and developing property enhancers.

These additives may be used individually or in combination of two or more.

Examples of abrasives include, but are not limited to, silica, Teflon® resin powder, polyvinylidene fluoride powder, cerium oxide powder, silicon carbide powder, and strontium titanate powder.

Examples of flowability enhancers include, but are not limited to, titanium oxide powder and aluminum oxide powder.

Examples of conductivity enhancers include, but are not limited to, zinc oxide powder, antimony oxide powder, and tin oxide powder.

Examples of developing property enhancers include, but are not limited to, oppositely charged white and black fine particles.

Examples of white fine particles include benzyl tributyl quaternary ammonium salts.

Such an example of black fine particles is ammonium salts of iron complexes.

### Volume Average Particle Diameter of Toner

There are no particular restrictions on the volume average particle size of the toner, and it can be appropriately selected according to a particular application. It is preferable that the toner's volume average particle size be between 1.2 times and 2.0 times the average particle size of the coloring pigment.

If the toner's volume average particle size is at least 1.2 times the average particle size of the coloring pigment, the problem of pigment protrusion, which can impair the toner's functionality, can be resolved.

If the toner's volume average particle size is at most 2.0 times the average particle size of the coloring pigment, the pigment hiding power is improved, resulting in sufficient gloss.

As for specific values of the toner's volume average particle size, a range of 12 μm to 20 μm is preferable.

If the toner's volume average particle size is at least 12 μm, the problem of pigment protrusion, which can impair the toner's functionality, can be resolved.

If the toner's volume average particle size is at most 20 μm, the issue of reduced spreadability during fixing and decreased substrate hiding power can be resolved.

There are no particular restrictions on the method of measuring the toner's volume average particle size, and it can be appropriately selected according to a particular application. For example, measurement can be performed using a Coulter Counter Multisizer III (available from Beckman Coulter, Inc.). The measurement sample is prepared by using an ultrasonic disperser to disperse the toner in an electrolyte solution containing a surfactant for one minute, followed by measurement of 50,000 particles.

### Volume Resistivity Value of Toner

Although the volume resistivity of the toner is not particularly limited and may be selected as appropriate according to a particular application, it is preferably from 9 to 13 log Ω·cm.

There are no particular restrictions on the method of measuring the volume resistivity of the toner, and it can be appropriately selected according to a particular application.

For example, a toner sample is pressure-molded under an applied load of 30 kg to form a pellet with a thickness of 1.0 mm. The molded toner is then placed in a container equipped with a cylindrical electrode with a diameter of φ18 mm, which includes a guard electrode. The volume resistivity at a frequency of 1 kHz is determined using a TR-10C AC bridge-type resistance measuring device (available from Ando Electric Co., Ltd.), based on the following Relationship 2:

$$Volume resistivity ( Ω \cdot cm ) = ( Resistance value ( Ω ) \times Main electrode area ( {cm}^{2} ) ) / Pellet thickness ( cm ) \qquad Relationship 2$$

### Molecular Weight of Toner

There are no specific restrictions on the number average molecular weight of the toner and it can be appropriately selected to suit a particular application. It is preferable for the number average molecular weight to be from 1,500 to 5,000.

here are no specific restrictions on the weight average molecular weight of the toner and it can be appropriately selected to suit a particular application. It is preferable for the weight average molecular weight to be from 5,000 to 30,000.

There are no particular restrictions on the method of measuring the number average molecular weight and weight average molecular weight of the toner, and it can be appropriately selected according to a particular application. For example, these can be measured using the following method:

The molecular weight distribution of the portion of the toner dissolved in tetrahydrofuran (THF) is measured using a gel permeation chromatography (GPC) measuring instrument (GPC-150C, available from Waters Corporation). A column (KF801 to KF807, available from SHODEX) is used for the measurement, and the following procedure is employed:

The column is stabilized in a 40 degrees Celsius heat chamber, after which THF is passed through the column at a flow rate of 1 mL/min at this temperature. Subsequently, 0.05 g of a sample is thoroughly dissolved in 5 g of THF, and the resulting solution is prefiltered using a Chromatodisc filter with a pore size of 0.45 μm (available from Kurabo Industries Ltd.).

Finally, the sample concentration is adjusted to between 0.05 percent by mass and 0.6 percent by mass, and 50 to 200 μL of the THF sample solution is injected for measurement.

The weight average molecular weight Mw and the number average molecular weight Mn of the sample portion dissolved in THE are calculated based on the relationship between the count values and the logarithm values of the calibration curves made from several types of monodispersed polystyrene standard samples.

As the standard polystyrene sample for the standard curve, it is suitable to use at least about ten standard polystyrene samples among, for example, polystyrene samples having a molecular weight of 6×10², 2.1×10², 4×10², 1.75×10⁴, 5.1×10⁴, 1.1×10⁵, 3.9×10⁵, 8.6×10⁵, 2×10⁶, or 4.48×10⁶, available from TOSOH CORPORATION or Pressure Chemical Co. The molecular weight is measured with a refractive index (RI) detector.

The object (transfer material) of the thermal transfer print sheet obtained by printing the toner onto a substrate is preferably ceramic, from the viewpoint of better image peeling protection.

The toner of the present disclosure can be used as a single component developing agent.

It is preferable that the developing agent related to the present disclosure includes both the toner of the present disclosure and a carrier.

As the carrier, for example, magnetic fine particles can be used.

There are no particular restrictions on the material of the magnetic fine particles, and it can be appropriately selected according to a particular application.

Examples include:
Spinel ferrite such as magnetite and gamma iron oxide
Spinel ferrite containing one or more metals other than iron (e.g., Mn, Ni, Zn, Mg, Cu)
Magnetoplumbite-type ferrite such as barium ferrite
Iron or alloys with an oxide layer on the surface.

There are no particular restrictions on the shape of the magnetic fine particles, and it can be appropriately selected depending on the purpose. For example, they may be either spherical or needle-shaped. In particular, for strong magnetization, it is preferable to use ferromagnetic particulates such as iron.

In addition, in terms of chemical stability, it is preferable to use magnetite or magnetoplumbite type ferrite such as spinel ferrite or barium ferrite containing gamma ferric oxide. A resin carrier with a desired magnetization can be used depending on the type and content of a ferromagnetic particle. Preferably, such a carrier has a magnetization of from 30 to 150 emu/g in 1,000 oersted.

Such resin carriers can be manufactured by spraying a melt-kneaded material of magnetized particulates and a binder resin having insulation property by a spray drier. Also, it is possible to manufacture resin carrier in which magnetized particulates are dispersed in a condensation type binder formed by reacting and curing monomers or prepolymers in an aqueous medium under the presence of magnetized particulates.

To control the chargeability of magnetized carrier, positively or negatively charged fine particles or electroconductive fine particles are fixated on the surface of the carrier or the surface is coated with a resin.

The coating material on the surface includes, but is not limited to, a silicone resin, acrylic resin, epoxy resin, and fluororesin. Of these, a silicone resin and an acrylic resin are preferable. Furthermore, it is also possible to coat the carrier with positively or negatively chargeable fine particles or conductive fine particles.

There are no particular restrictions on the content of each component in the developing agent, and it can be appropriately selected according to a particular application. A mixing ratio that results in a toner concentration of 2 to 10 percent by mass is preferable.

### Toner Set for Thermal Transfer Print Sheets

The toner set for a thermal transfer print sheet of the present disclosure includes: a black toner containing a polyester resin with an acid value of at least 25 mgKOH/g, a black pigment, a release agent, and a curing agent, and at least one of a cyan toner containing a polyester resin with an acid value of at least 25 mgKOH/g, a cyan pigment, a release agent, and a curing agent, a magenta toner containing a polyester resin with an acid value of at least 25 mgKOH/g, a magenta pigment, a release agent, and a curing agent, and a yellow toner containing a polyester resin with an acid value of at least 25 mgKOH/g, a yellow pigment, a release agent, and a curing agent.

The set may furthermore optionally contain other components.

The composition of each toner is the same as that described in the section on Toner for Thermal Transfer Print Sheet, except for the difference in color pigments, and thus its detailed description is omitted.

### Storage Container for Toner for Thermal Transfer Print Sheet

The storage container for a toner for a thermal transfer print sheet of the present disclosure is capable of containing toner for thermal transfer print sheets. The storage container for a toner for a thermal transfer print sheet may also include other optional components.

The storage container for a toner for a thermal transfer print sheet refers to a unit with a function to store toner, in which the toner is contained. Examples of the storage container for a toner for a thermal transfer print sheet include, but are not limited to, a toner accommodating container, a developing unit, and a process cartridge.

The toner accommodating container is a vessel containing a toner.

The developing unit refers to a device that accommodates toner and develops with the toner.

The process cartridge includes at least a latent electrostatic image bearer integrated with a developing device, accommodates toner, and is detachably attachable to an image forming device. The process cartridge may furthermore include at least one member selected from the group consisting of a charger, an exposure (quencher, discharger), and a cleaning device.

An embodiment of the toner storage container for the toner for a thermal transfer print sheet of the present disclosure is described with reference to the drawings. The present disclosure is not limited to these embodiments.

In the drawings, identical components may be denoted by the same reference numerals (or symbols), and redundant descriptions may be omitted. Additionally, the present disclosure is not restricted to the specific numbers, positions, or shapes of the configurations described below. These parameters may be appropriately selected to suit the implementation of the present disclosure.

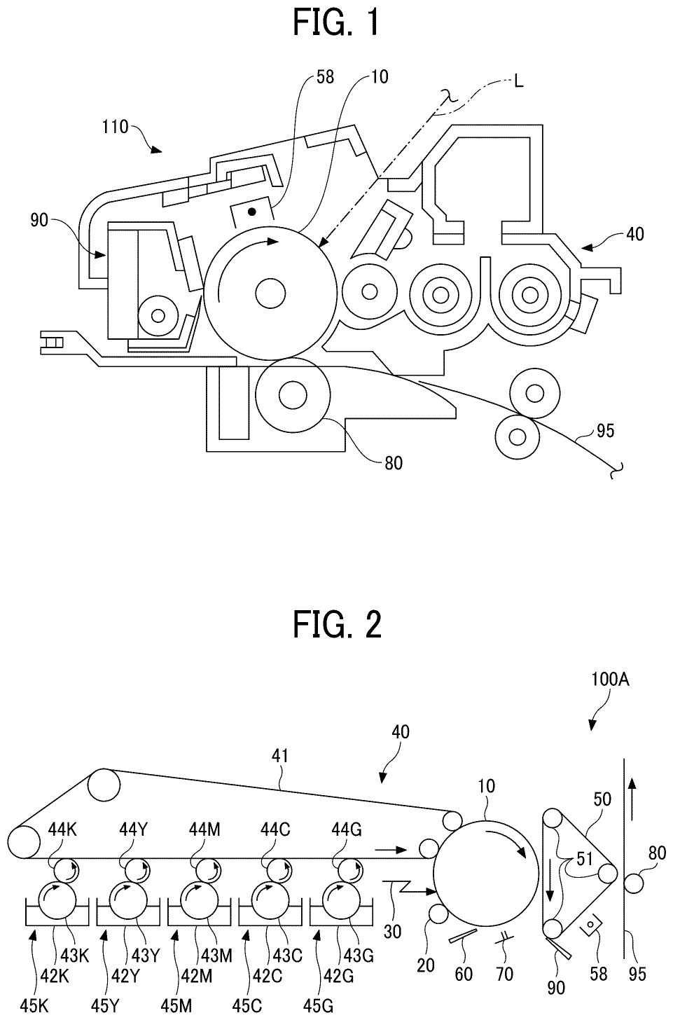

FIG. 1 is a diagram illustrating a toner storage container for the toner for a thermal transfer print sheet according to an embodiment of the present disclosure.

A process cartridge 110 includes a drum photoconductor (latent electrostatic image bearer) 10, a corona charger 58, a developing device 40, a transfer roller 80, and a cleaning device (cleaner) 90.

In FIG. 1, L represents beams of light from an irradiation device and 95 represents a transfer medium.

The drum photoconductor 10 can be the same as that of the latent electrostatic image bearer in the image forming device. Any known charging member is used as the corona charger 58.

In the image forming process by the process cartridge 110 illustrated in FIG. 1, the drum photoconductor 10 undergoes charging by the corona charger 58 and exposure to the beams of light L by an irradiator while rotating in the direction indicated by an arrow, resulting in the formation of a latent electrostatic image corresponding to the exposed image on its surface. This latent electrostatic image is developed with toner by the developing device 40. The toner image obtained is transferred by the transfer roller 80 to the transfer sheet 95 and printed out. The surface of the latent image bearer after image transfer is cleaned by the cleaning unit 90 and discharged by a discharging device to be ready for the next image formation process.

### Method of Manufacturing Thermal Transfer Print Sheet and Apparatus for Manufacturing Thermal Transfer Print Sheet

The method of manufacturing a thermal transfer print sheet according to the present disclosure includes forming an image on a substrate using the toner for a thermal transfer print sheet and may also optionally include another optional process A.

The apparatus for manufacturing the thermal transfer printing sheet according to the present disclosure includes an image forming device for forming an image on a substrate and may also include a toner storage container and another optional device A.

The image forming process can be conducted by the image forming device.

Note that the configuration of the toner is omitted here to avoid redundancy with the section on Toner for Thermal Transfer Printing Sheet.

### Image Forming Process and Image Forming Apparatus

The image forming process is not particularly limited as long as it can form an image on a substrate using the toner for a thermal transfer printing sheet and may be appropriately selected according to a particular application. It is preferable that it include a latent electrostatic image forming process, a developing process, a transfer process, and a fixing process. The image forming process may also include another optional process B.

The image forming device is not particularly limited as long as it can form an image on a substrate and may be appropriately selected according to a particular application. It is preferable that it include a latent electrostatic image forming device, a developing device, a transfer device, and a fixing device. The image forming device may also include another optional device B.

### Substrate

The substrate has no specific limitation and can be suitably selected to suit to a particular application. For example, it includes a ceramic mug cup and ceramic tile.

### Latent Electrostatic Image Forming Process and Latent Electrostatic Image Forming Device

In the latent electrostatic image forming process, a latent electrostatic image is formed on a latent electrostatic image bearer. The latent electrostatic image forming process includes, for instance, charging the surface of the latent electrostatic image bearer and subsequently exposing it to image-like irradiation, accomplished by the latent electrostatic image forming device.

The latent electrostatic image forming device forms a latent electrostatic image on the latent electrostatic image bearer. The latent electrostatic image forming device preferably includes at least a charging device (charger) that charges the surface of the latent electrostatic image bearer and an irradiating device for irradiating the surface of the latent electrostatic image bearer with light according to the obtained image information.

### Latent Electrostatic Image Bearer

The material, size, and structure of the latent electrostatic image bearer is not particularly limited, and it can be suitably selected among the devices known in the art to suit to a particular application.

Specific examples of the materials include, but are not limited to, inorganic compounds such as amorphous silicon and selenium and organic compounds such as polysilane and phthalopolymethine. Of these, amorphous silicon is preferable in terms of long working life.

The linear speed of the latent electrostatic image bearer is preferably at least 300 mm/s.

### Charger and Charging

The charging device (charger) is not particularly limited and can be suitably selected to suit to a particular application.

Specific examples include, but are not limited to, a known contact type charger that includes an electroconductive or semiconductive roller, brush, film, or a rubber blade, and a non-contact type charger using corona discharging such as corotron and scorotron. Of these, using a contact type charger is preferable for obtaining an image forming apparatus with reduced ozone production.

The charging device may employ any form other than the roller, for example, a magnetic brush, and a fur brush and can be selected according to the specification or form of an image forming apparatus.

The charging is conducted by applying a bias to the image bearer's surface with the charger, for example.

### Irradiating Device and Irradiation

The irradiating device (irradiator) is not particularly limited and can be suitably selected to suit to a particular application as long as it can irradiate the surface of a latent electrostatic image bearer charged with the charger imagewise.

Specific examples include, but are not limited to, a photocopying optical system, a rod lens array system, a laser optical system, and a liquid crystal shutter optical system.

The light source for use in the irradiation device has no particular limit and can be suitably selected to suit to a particular application.

Specific examples include, but are not limited to, typical luminous materials such as a fluorescent lamp, a tungsten lamp, a halogen lamp, a mercury lamp, a sodium lamp, a light emitting diode (LED), a semiconductor laser (LD), and electroluminescence (EL).

Variety of optical filters can be used as the light source for used in the irradiator to irradiate a latent electrostatic image bearer with beams of light having only a desired wavelength.

It includes, but is not limited to, a sharp cut filter, a band-pass filter, a near infrared filter, a dichroic filter, a coherent filter, and a color conversion filter.

The irradiation is conducted by irradiating the surface of the latent electrostatic image bearer with an irradiator according to image information. The dorsal irradiation system, in which a latent electrostatic image bearer is irradiated from its rear side can be also employed.

### Developing Process and Developing Device

In the developing process, toner images are formed by developing a latent electrostatic image. The developing process is suitably executed by the developing device.

The developing device forms toner images by developing latent electrostatic images. Preferably, the developing device includes a stirrer for triboelectrically charging toner, a magnetic field generator fixed inside, and a rotatable developing agent bearer that bears a developing agent containing the toner on its surface.

### Transfer Process and Transfer Device

In the transfer process, a toner image is transferred onto a substrate and preferably includes a primary transfer process, in which the toner image is transferred onto an intermediate transfer body to form a composite transfer image, and a secondary transfer process, in which the composite transfer image is transferred onto the substrate.

The transfer device transfers a toner image onto a substrate and preferably includes a primary transfer device, which transfers the toner image onto an intermediate transfer body to form a composite transfer image, and a secondary transfer device, which transfers the composite transfer image onto the substrate.

The toner image is transferred by, for example, charging the latent electrostatic image bearer with the transfer charging device in the transfer device.

If an image secondarily transferred to the substrate is a color image formed of multiple color toners, it is possible to have a configuration in which each color toner image is sequentially overlapped on the intermediate transfer body by the transfer device to form an image thereon, which is secondarily transferred once to the substrate by an intermediate transfer device.

The intermediate transfer body is not particularly limited and can be suitably selected from the known transfer members including a transfer belt.

The transfer device (the primary transfer device and the secondary transfer device) preferably includes a transfer unit for peeling-charge the toner image formed on the latent electrostatic image bearer or photoconductor to peel the image to the printing medium.

Specific examples of the transfer device include, but are not limited to, a corona transfer unit using corona discharging, a transfer belt, a transfer roller, a pressure transfer roller and an adhesive transfer device.

A typical example of the substrate is plain paper but any paper to which a non-fixed image after development is transferred can be suitably used. PET base for an overhead projector can be also used.

### Fixing Process and Fixing Device

In the fixing process, the image is transferred to the substrate. For example, fixing can be performed every time each color toner image is transferred or at once for a multi-color overlapped image. The fixing process can be conducted by the fixing device.

The fixing device fixes the transfer image transferred to the substrate, including a known heating and pressing member.

A combination of a heating roller and a pressure roller and a combination of a heating roller, a pressure roller, and an endless belt can be used as the heating and pressing member.

There is no specific limit to the heating temperature at the heating and pressing member, and it can be suitably selected to suit to a particular application. Preferably, the temperature is from 80 to 200 degrees Celsius.

There is no specific limitation to the surface pressure in the fixing process and it can be suitably selected to suit to a particular application. Preferably the surface pressure is from 10 to 80 N/cm².

In the present disclosure, for example, any known optical fixing device can be used in combination with or in place of the fixing device depending on a particular application.

### Other Optional Process B and Other Optional Device B

The other optional process B is not particularly limited and can be suitably selected to suit to a particular application. Examples include, but are not limited to, a cleaning process, a discharging process, and a recycling process.

The other optional device B is not particularly limited and can be suitably selected to suit to a particular application. It includes a cleaning device, a discharging device, and a recycling device.

In addition, the other optional process B is suitably conducted by the other optional device B.

### Cleaning Process and Cleaning Device

Any cleaning process that can remove the toner remaining on the latent electrostatic image bearer is suitably used. For example, the cleaning process can be conducted by the cleaning device.

There is no specific limitation to the selection of the cleaning device and any known cleaner that can remove the toner remaining on the latent electrostatic image bearer is suitably selected to suit to a particular application. Specific examples of such cleaners include, but are not limited to, a magnetic brush cleaner, an electrostatic brush cleaner, a magnetic roller cleaner, a blade cleaner, a brush cleaner, and a web cleaner.

### Discharging Process and Discharging Device

The discharging process has no specific limitation as long as it includes applying a discharging bias to a latent electrostatic image bearer for discharging and can be suitably selected to suit to a particular application. For example, the charging process can be conducted by the charging device.

The discharging device has no particular limitation as long as it can apply a discharging bias to a latent electrostatic image bearer for discharging and can be suitably selected to suit to a particular application. For example, a discharging lamp is suitable.

### Recycling Process and Recycling Device

The recycling process has no particular limitation as long as it includes recycling toner removed in the cleaning process to the developing device and can be suitably selected to suit to a particular application. For example, the recycling process can be conducted by the recycling device.

The recycling device has no particular limitation as long as it recycles toner removed in the cleaning process to the developing device and can be suitably selected to suit to a particular application. For example, known conveying devices are suitable.

Embodiments of the apparatus for manufacturing a thermal transfer print sheet of the present disclosure is described with reference to the drawings. The present disclosure is not limited to these embodiments.

In the drawings, identical components may be denoted by the same reference numerals (or symbols), and redundant descriptions may be omitted. Additionally, the present disclosure is not restricted to the specific numbers, positions, or shapes of the configurations described below. These parameters may be appropriately selected to suit the implementation of the present disclosure.

FIG. 2 is a diagram illustrating a schematic configuration of the apparatus for manufacturing thermal transfer print sheets according to an embodiment of the present disclosure.

A device 100A for manufacturing thermal transfer print sheets includes the drum photoconductor 10 as a latent electrostatic image bearer, a charging roller 20 as a charging device, an irradiator 30 as an irradiating device, a developing device 40 as a developing device, an intermediate transfer body (intermediate transfer belt) 50, a cleaner 60 as a cleaning device, a discharging lamp 70 as a discharging device, a transfer roller 80 as a transfer device, and an intermediate transfer body cleaning device 90.

The intermediate transfer body 50 is an endless belt stretched over three rollers 51 disposed inside and they move the intermediate transfer body 50 in the direction indicated by an arrow in FIG. 2. The three rollers 51 partially serves as a transfer bias roller to apply a transfer bias (primary transfer bias) to the intermediate transfer body 50. Around the intermediate transfer body 50 is disposed the intermediate transfer body cleaning device 90. In addition, the transfer roller 80 is disposed near facing the intermediate transfer body 50. The transfer roller 80 applies a transfer bias (secondary transfer bias) to the intermediate transfer body 50 to secondarily transfer the developed toner image to a transfer sheet 95 as the substrate. Around the intermediate transfer body 50, a corona charger 58 for applying charges to the toner image on the intermediate transfer body 50 is disposed between the contact portion of the drum photoconductor 10 and the intermediate transfer body 50 and the contact portion of the intermediate transfer body 50 and the transfer sheet 95 as the substrate along the rotation direction of the intermediate transfer body 50.

The developing device 40 includes a developing belt 41 as the developing agent bearer, a black (Bk) developing unit 45K, a yellow (Y) developing unit 45Y, a magenta (M) developing unit 45M, a cyan (C) developing unit 45C, and an other toner (G) developing unit 45G containing other toner G, all of which are disposed around the developing belt 41.

The developing belt 41 is an endless belt stretched over multiple belt rollers and moves in the direction indicated by an arrow in FIG. 2. Furthermore, the developing belt 41 is partially in contact with the drum photoconductor 10.

The black developing unit 45K includes a developing agent accommodating unit 42K, a developing agent supplying roller 43K, and a developing roller (developing agent bearer) 44K.

The yellow developing unit 45Y includes a developing agent accommodating unit 42Y, a developing agent supplying roller 43Y, and a developing roller 44Y.

The magenta developing unit 45M includes a developing agent accommodating unit 42M, a developing agent supplying roller 43M, and a developing roller 44M.

The cyan developing unit 45C includes a developing agent accommodating unit 42C, a developing agent supplying roller 43C, and a developing roller 44C.

The other toner developing unit 45G includes a developing agent accommodating unit 42G, a developing agent supplying roller 43G, and a developing roller 44G. The other toner is not particularly limited. For example, it includes white toner and transparent color toner.

The method of forming images using the device 100A for manufacturing a thermal transfer print sheet is described next.

First, after the charging roller 20 uniformly charges the surface of the drum photoconductor 10, the irradiator 30 irradiates the drum photoconductor 10 with the irradiation light to form a latent electrostatic image. Next, the latent electrostatic image formed on the drum photoconductor 10 is developed using toner supplied from the developing device 40, thereby forming a toner image. The toner image formed on the drum photoconductor 10 is primarily transferred to the intermediate transfer body 50 by a transfer bias applied by the roller 51, and then secondarily transferred to the transfer sheet 95, which is fed from a paper feeder, by a transfer bias applied by the transfer roller 80. After the toner image is transferred from the drum photoconductor 10 to the intermediate transfer body 50, the cleaner 60 removes the toner remaining on the surface of the drum photoconductor 10. Then the discharging lamp 70 discharges the drum photoconductor 10. The residual toner on the intermediate transfer body 50 after transfer is removed by the intermediate transfer body cleaning device 90.

After this transfer, the transfer sheet 95 is conveyed to a fixing unit, where the transferred toner image is fixed on the transfer sheet 95.

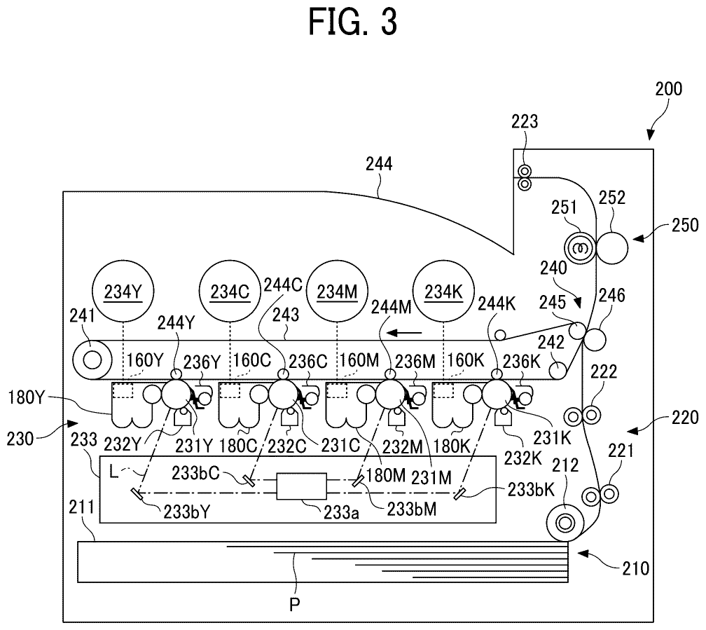

FIG. 3 is a diagram illustrating a schematic configuration of the apparatus for manufacturing thermal transfer print sheets according to another embodiment of the present disclosure.

One typical example of the apparatuses for manufacturing thermal transfer print sheets is a printer. The apparatuses are not particularly limited and include photocopiers, facsimile machines, and multifunction peripherals as long as they can form images with toner.

An apparatus 200 for manufacturing thermal transfer print sheets includes a sheet feeding unit 210, a conveyance unit 220, an image forming part (latent electrostatic image forming device) 230, a transfer unit (transfer device) 240, and a fixing unit (fixing device) 250.

The sheet feeding unit 210 includes a sheet feeding cassette 211 on which sheets to be fed are piled and a feeding roller 212 that feeds a sheet (transfer medium) P piled on the sheet feeding cassette 211 one by one.

The conveyance unit 220 includes a roller 221 for conveying the sheet P fed by the feeding roller 212 toward the transfer device 240, a pair of timing rollers 222 for pinching the front end of the sheet P conveyed by the roller 221 on standby and sending out the sheet P to the transfer device 240 at a particular timing, and ejection rollers 223 for ejecting the sheet P on which a color toner image is fixed by the fixing device 250 to an ejection tray 224.

In FIG. 3, the image forming part 230 includes an image forming unit (latent electrostatic image bearer) 180Y that forms an image using a developing agent containing yellow toner, an image forming unit 180C that forms an image using a developing agent containing cyan toner, an image forming unit 180M that forms an image using a developing agent containing magenta toner, and an image forming unit 180K that forms an image using a developing agent containing black toner, sequentially standing from left to right in the drawing with a particular interval, and an irradiator 233.

The image forming unit 180 (180Y, 180C, 180M, 180K) is provided to be rotatable clockwise in the drawing and includes a drum photoconductor 231 (231Y, 231C, 231M, 231K) where latent electrostatic images and toner images are formed, a charger 232 (232Y, 232C, 232M, 232K) for uniformly charging the surface of the drum photoconductor 231 (231Y, 231C, 231M, 231K), and a cleaner 236 (236Y, 236C, 236M, 236K) for removing residual toner from the surface of the drum photoconductor 231 (231Y, 231C, 231M, 231K).

The image forming unit 180 (180Y, 180C, 180M, 180K) includes toner bottles 234 (234Y, 234C, 234M, 234K) for containing toner for each color, and sub-hoppers 160 (160Y, 160C, 160M, 160K) for replenishing toner supplied from the toner bottles 234 (234Y, 234C, 234M, 234K).

Any of the image forming units 180 (180Y, 180C, 180M, 180K) can be referred to as an image forming unit when it indicates an arbitrary unit.

The irradiator 233 includes a polygon mirror 233b (233bY, 233bC, 233bM, 233bK) that is rotationally driven by a motor. This mirror reflects a laser beam L emitted from a light source 233a based on image information, and the reflected beam is used to irradiate the drum photoconductor 231 (231Y, 231C, 231M, 231K).

In addition, the developing agent contains toner and carrier. The four image forming units 180 (180Y, 180C, 180M, 180K) have substantially the same structure except for the individual developing agents used for respective image forming units.

In FIG. 3, the transfer unit 240 includes a driving roller 241, a driven roller 242, an intermediate transfer belt 243 disposed rotatable counterclockwise in the drawing in accordance with the drive of the driving roller 241, a primary transfer roller 244 (244Y, 244C, 244M, and 244K) disposed facing the drum photoconductor 231 (231Y, 231C, 231M, and 231K) with the intermediate transfer belt 243 therebetween, and a secondary facing roller 245 and a secondary transfer roller 246 disposed facing each other at the point of the toner image transferred to the sheet P with the intermediate transfer belt 243 therebetween.

A fixing unit 250 with a heater inside includes a fixing belt 251 for heating the sheet P and a pressing roller 252 for forming a nip with the fixing belt 251 by rotatably pressing it. Heat is applied with pressure to the color toner image on the sheet P at the nipping portion, thereby fixing the color toner image. The sheet P on which the color toner image is fixed is ejected to the ejection tray 224 by the ejection rollers 223, which completes a series of image forming process.

### Printing Method and Printing Apparatus

The printing method of the present disclosure includes an image forming process in which an image is formed on a substrate using the toner for thermal transfer print sheets, and a thermal transfer process in which the image is thermally transferred onto a transfer medium. It may furthermore optionally include other processes.

The printing apparatus related to the present disclosure includes an image forming device for forming an image on a substrate using toner for thermal transfer print sheets, and a thermal transfer device for thermally transferring the image onto a transfer medium. It may furthermore optionally include other devices.

The printing method can be suitably carried out using the printing apparatus.

It should be noted that the descriptions of the image forming process and the image forming device are omitted here to avoid redundancy with the sections on Method of Manufacturing Thermal Transfer Print Sheet and Apparatus for Manufacturing Thermal Transfer Print Sheet.

### Thermal Transfer Process and Thermal Transfer Device

In the thermal transfer process, an image, obtained through the image forming process is thermally transferred onto a transfer medium.

The thermal transfer device thermally transfers an image, obtained through the image forming process, onto a transfer medium. There are no particular limitations on the thermal transfer device, and it may be appropriately selected according to a particular application. One typical example is a manual iron press machine for a mug, such as the ROBS.

There are no particular limitations on the transfer medium, and it may be appropriately selected according to a particular application. From the perspective of better image peeling prevention, ceramics are preferred.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative Examples but is not limited thereto. In the following Examples and Comparative Examples, “parts” represents “parts by mass” and, “percent”, “percent by mass”, unless otherwise specified.

### Synthesis of Monoester Wax

A one liter four-neck flask equipped with a thermometer, nitrogen inlet tube, stirrer, and condenser was charged with 50 parts by mass of cerotic acid and 50 parts by mass of palmitic acid as fatty acid components, along with 100 parts by mass of ceryl alcohol as an alcohol component, adjusting the total weight to 500 g. The mixture was then heated under a nitrogen stream at 220 degrees Celsius for at least 15 hours under atmospheric pressure, during which reaction byproducts were distilled off. As a result, a monoester wax with a melting point of 70.5 degrees Celsius was obtained.

### Manufacturing of Toner Particle 1

### Manufacturing of Mother Toner Particle 1

Carbon black (C-44, available from Mitsubishi Chemical Corporation): 6.0 parts
Polyester resin, RN-290, available from Kao Corporation: 74.5 parts by mass
   (Mw: 52,000, Mn: 2,000, acid value: 28 mgKOH/g)
Curing agent (Primid XL-552, available from MS-CHEMIE (Japan) Ltd.): 10.0 parts
Styrene acrylic copolymer (EXD-001, available from Sanyo Chemical Industries, Ltd.): 4.0 parts
   (Tg: 68 degrees Celsius, Mw: 13,000)
Monoester wax (mp: 70.5 degrees Celsius: 5.0 parts
Salycylic acid derivative zirconium salt (available from HODOGAYA CHEMICAL CO., LTD.): 0.5 parts

The toner materials specified above were preliminarily mixed by a HENSCHEL MIXER (FM20B, available from NIPPON COKE & ENGINEERING CO., LTD.) and thereafter, melt-kneaded at 130 to 150 degrees Celsius by a one-shaft kneader (Ko-Kneader, available from BUSS AG). The thus-obtained kneaded mixture was cooled down to room temperature and coarsely pulverized to 200 to 300 μm with Rotoplex. The coarsely pulverized mixture was subsequently subjected to fine pulverization using a counter-jet mill (100AFG, available from Hosokawa Micron Corporation), during which the grinding air pressure was appropriately adjusted to achieve a weight-average particle diameter of 6.9±2.0 μm.

The resulting powder was then classified using an air classifier (EJ-LABO, available from MATSUBO Corporation), while the louver opening was adjusted as appropriate, to obtain Mother Toner Particle 1, which had the following characteristics:
a weight-average particle diameter of 7.5±2.0 μm,
a weight-average to number-average particle diameter ratio of at most 1.24,
particles smaller than 5 μm accounting for at most 35.0 percent, and
particles smaller than 13 μm accounting for at most 2.0 percent.

### Mixing Treatment

To 100 parts of the obtained mother toner particles, 0.65 parts of an additive (UFP-35, available from Denka Company Limited) and 0.45 parts of an additive (ZD-30ST, available from Tokuyama Corporation) were added.

For the mixing process, a Henschel mixer (FM20C/I, available from Nippon Coke & Engineering Co., Ltd.) was used, operating at 2,000 rpm with a cycle of 1 minute of rotation followed by 1 minute of stoppage, repeated 10 times (total mixing time: 10 minutes), thereby obtaining Toner Particle 1.

### Manufacturing of Toner Particle 2

### Manufacturing of Mother Toner Particle 2

Carbon black (C-44, available from Mitsubishi Chemical Corporation): 6.0 parts
Polyester resin, RN-290, available from Kao Corporation: 64.8 parts by mass
   (Mw: 52,000, Mn: 2,000, acid value: 28 mgKOH/g)
Polyester resin, RN-300, available from Kao Corporation: 9.7 parts by mass
   (Mw: 14,000, Mn: 3,500, acid value: 4 mgKOH/g)
Curing agent (Primid XL-552, available from MS-CHEMIE (Japan) Ltd.): 10.0 parts
Styrene acrylic copolymer (EXD-001, available from Sanyo Chemical Industries, Ltd.): 4.0 parts (Tg: 68 degrees Celsius, Mw: 13,000)
Monoester wax (mp: 70.5 degrees Celsius: 5.0 parts
Salycylic acid derivative zirconium salt (available from HODOGAYA CHEMICAL CO., LTD.): 0.5 parts

Toner Particle 2 was manufactured in the same manner as Toner Particle 1 except that the toner raw materials were changed as specified above.

### Manufacturing of Toner Particle 3

### Manufacturing of Mother Toner Particle 3

Carbon black (C-44, available from Mitsubishi Chemical Corporation): 6.0 parts
Polyester resin, RN-290, available from Kao Corporation: 79.5 parts by mass
   (Mw: 52,000, Mn: 2,000, acid value: 28 mgKOH/g)
Curing agent (Primid XL-552, available from MS-CHEMIE (Japan) Ltd.): 5.0 parts
Styrene acrylic copolymer (EXD-001, available from Sanyo Chemical Industries, Ltd.): 4.0 parts (Tg: 68 degrees Celsius, Mw: 13,000)
Monoester wax (mp: 70.5 degrees Celsius: 5.0 parts
Salycylic acid derivative zirconium salt (available from HODOGAYA CHEMICAL CO., LTD.): 0.5 parts

Toner Particle 3 was manufactured in the same manner as Toner Particle 1 except that the toner raw materials were changed as specified above.

### Manufacturing of Toner Particle 4

### Manufacturing of Mother Toner Particle 4

Carbon black (C-44, available from Mitsubishi Chemical Corporation): 6.0 parts
Polyester resin, RN-290, available from Kao Corporation: 64.5 parts by mass
   (Mw: 52,000, Mn: 2,000, acid value: 28 mgKOH/g)
Curing agent (Primid XL-552, available from MS-CHEMIE (Japan) Ltd.): 20.0 parts
Styrene acrylic copolymer (EXD-001, available from Sanyo Chemical Industries, Ltd.): 4.0 parts (Tg: 68 degrees Celsius, Mw: 13,000)
Monoester wax (mp: 70.5 degrees Celsius: 5.0 parts
Salycylic acid derivative zirconium salt (available from HODOGAYA CHEMICAL CO., LTD.): 0.5 parts

Toner Particle 4 was manufactured in the same manner as Toner Particle 1 except that the toner raw materials were changed as specified above.

### Manufacturing of Toner Particle 5

### Manufacturing of Mother Toner Particle 5

Carbon black (C-44, available from Mitsubishi Chemical Corporation): 6.0 parts
Polyester resin, RN-290, available from Kao Corporation: 74.5 parts by mass (Mw: 52,000, Mn: 2,000, acid value: 28 mgKOH/g)
Curing agent (Primid XL-552, available from MS-CHEMIE (Japan) Ltd.): 10.0 parts
Styrene acrylic copolymer (EXD-001, available from Sanyo Chemical Industries, Ltd.): 4.0 parts (Tg: 68 degrees Celsius, Mw: 13,000)
Monoester wax (mp: 70.5 degrees Celsius: 5.0 parts
Salycylic acid derivative zirconium salt (available from HODOGAYA CHEMICAL CO., LTD.): 0.5 parts

The toner's raw materials were first pre-mixed using a Henschel mixer (FM20B, available from Nippon Coke & Engineering Co., Ltd.).

The resulting mixture was then melt-kneaded at 90 degrees Celsius using a batch-type kneader (Wonder Kneader WDS7-30, available from Moriyama Mfg. Works, Ltd.). The resulting kneaded mixture was extruded through a 3 mm diameter die using a feeder-loader to form strands, which were cooled in a water bath maintained at 15 degrees Celsius or lower. The solidified strands were then cut with a pelletizer to obtain Toner Pellet 1, each having a diameter and length of 2 mm. Toner Pellet 1 is a coarsely ground product of the toner component melt-kneaded mixture.

Subsequently, the pellets were charged into a cooling apparatus and cooled with liquid nitrogen, and then pulverized using a mechanical pulverizer (Linrex Mill LX, available from Hosokawa Micron Corporation). The pulverized product discharged from the pulverizer was sieved through a 25 μm mesh to obtain particles that passed through the mesh. Particles that did not pass through were returned to the pulverizer for re-pulverization.

The particles that passed through the 25 μm mesh were returned to room temperature. They were then subjected to fine classification using an air classifier (EJ-LABO, available from MATSUBO Corporation). During this process, the louver opening was appropriately adjusted to ensure that particles having a diameter of at most 5 μm accounted for no more than 10 percent by number, thereby yielding Toner Particle 5.

### Manufacturing of Toner Particle 6

### Manufacturing of Mother Toner Particle 6

Carbon black (C-44, available from Mitsubishi Chemical Corporation): 6.0 parts
Polyester resin, RN-290, available from Kao Corporation: 74.5 parts by mass (Mw: 52,000, Mn: 2,000, acid value: 28 mgKOH/g)
Curing agent (Blonate® 2304, available from Blonate Co., Ltd.): 10.0 parts Polyisocyanate-based curing agent
Styrene acrylic copolymer (EXD-001, available from Sanyo Chemical Industries, Ltd.): 4.0 parts (Tg: 68 degrees Celsius, Mw: 13,000)
Monoester wax (mp: 70.5 degrees Celsius: 5.0 parts
Salycylic acid derivative zirconium salt (available from HODOGAYA CHEMICAL CO., LTD.): 0.5 parts

Toner Particle 6 was manufactured in the same manner as Toner Particle 1 except that the toner raw materials were changed as specified above.

### Manufacturing of Toner Particle 7

### Manufacturing of Mother Toner Particle 7

Carbon black (C-44, available from Mitsubishi Chemical Corporation): 6.0 parts
Polyester resin, RN-300, available from Kao Corporation: 74.5 parts by mass (Mw: 14,000, Mn: 3,500, acid value: 4 mgKOH/g)
Curing agent (Primid XL-552, available from MS-CHEMIE (Japan) Ltd.): 10.0 parts
Styrene acrylic copolymer (EXD-001, available from Sanyo Chemical Industries, Ltd.): 4.0 parts (Tg: 68 degrees Celsius, Mw: 13,000)
Monoester wax (mp: 70.5 degrees Celsius: 5.0 parts
Salycylic acid derivative zirconium salt (available from HODOGAYA CHEMICAL CO., LTD.): 0.5 parts

Toner Particle 7 was manufactured in the same manner as Toner Particle 1 except that the toner raw materials were changed as specified above.

### Manufacturing of Toner Particle 8

### Manufacturing of Mother Toner Particle 8

Carbon black (C-44, available from Mitsubishi Chemical Corporation): 6.0 parts
Polyester resin, RN-290, available from Kao Corporation: 84.5 parts by mass (Mw: 52,000, Mn: 2,000, acid value: 28 mgKOH/g)
Styrene acrylic copolymer (EXD-001, available from Sanyo Chemical Industries, Ltd.): 4.0 parts (Tg: 68 degrees Celsius, Mw: 13,000)
Monoester wax (mp: 70.5 degrees Celsius: 5.0 parts
Salycylic acid derivative zirconium salt (available from HODOGAYA CHEMICAL CO., LTD.): 0.5 parts

Toner Particle 8 was manufactured in the same manner as Toner Particle 1 except that the toner raw materials were changed as specified above.

### Example 1

### Manufacturing of Developing Agent

### Manufacturing of Carrier

Silicone resin (Organo straight silicone): 100 parts
Toluene (available from Kanto Chemical CO.,INC.): 100 parts
γ-(2-aminoethyl)aminopropyl trimethoxy silane: 5 parts
   (available from Dow Toray Co.,Ltd.)
Carbon black (available from Mitsubishi Chemical Corporation): 10 parts

The mixture of the raw materials specified above was dispersed by a Homomixer for 20 minutes to prepare a liquid for forming a coating layer. The liquid was applied to the surface of spherical ferrite particles having an average particle diameter of 35 μm using a fluidized bed coater, so as to form an inner resin layer with an average coating thickness of 0.20 μm. With the same fluidized bed coating apparatus, the coating and drying were performed with the temperature inside the fluidized bed controlled at 70 degrees Celsius. The resulting carrier was then heat-treated in an electric furnace at 180 degrees Celsius for 2 hours, followed by particle size adjustment through sieving to obtain the final carrier.

### Manufacturing of Two Component Developing Agent 1

Toner Particle 1 and the final carrier obtained were uniformly mixed and charged by a TURBULA® mixer (available from Willy A. Bachofen AG) at 48 rpm for five minutes to manufacture Two-component Developing Agent 1. The toner-to-carrier mixing ratio was adjusted to match the initial toner concentration of the developing agent-4 percent by mass-in the evaluation machine.

### Method of Producing Transfer Sheet Image

The Two-component Developing Agent 1 was set in the black station of a RICOH Pro C7200S (available from Ricoh Co., Ltd.), and the process controller was used to adjust the developing and transferring conditions such that the toner deposition amount was 0.40 mg/cm². A black unfixed solid image was then output onto transfer paper (CPM6.2, available from Piotec Co., Ltd.).

### Method of Producing Tile Image

A tile base was overlaid on the solid image formed on the transfer paper, and the assembly was placed in a heat press machine (Model HTP234PS1, available from Piotec Corporation), where heat at 160 degrees Celsius was applied for 20 minutes under a pressure of 600 g/cm².

The transfer paper was then peeled off, and the solid image was fixed onto the tile, thus producing Tile Image 1.

Using the obtained Tile Image 1, the following evaluation was conducted.

### Evaluation of Image Peeling

A smear tester (Type I friction tester, JIS L0823 format (Test methods for colour fastness to rubbing), friction head diameter: 15φ) was used. A piece of white cotton cloth (JIS L0803 format, Standard adjacent fabrics for staining of colour fastness test, Cotton Type 3) of approximately 25×25 mm was affixed to the friction head using double-sided tape such that the fiber direction was horizontal to the direction of movement of the friction head. Subsequently, the Tile Image 1 was rubbed back and forth 30 times in continuous motion, and the result was observed visually. Image peeling was evaluated based on the following criteria. The results are shown in Table 1.

### Evaluation Criteria

S: No change in image color or appearance
A: Image color is sufficient, but rub marks are visible on the rubbed area
B: Image color is sufficient, but the rubbed area is faded
C: Noticeable image peeling such as loss of image observed

### Examples 2 to 6

Except for the use of the toner particles listed in Table 1, Two-component Developing Agents 2 to 6 and Tile Images 2 to 6 were produced in the same manner as in Example 1. Image peeling evaluation was conducted. The results are shown in Table 1.

### Comparative Examples 1 to 2

Except for the use of the toner particles listed in Table 1, Two-component Developing Agents 7 to 8 and Tile Images 7 to 8 were produced in the same manner as in Example 1. Image peeling evaluation was conducted, and the results are shown in Table 1. The results are shown in Table 1.

TABLE 1

| | Toner particle | | | | | |
|---|---|---|---|---|---|---|
| | | Acid value | Curing agent (parts) | | | |
| | | of polyester | | Amount | | Evaluation |
| | | resin | | added | Tile | on image |
| | No. | (mgKOH/g) | | (parts) | image | peeling |
| Example 1 | 1 | 28 | β- | 10 | 1 | S |
| | | | hydroxyalkyl | | | |
| | | | amide | | | |
| Example 2 | 2 | 25 | β- | 10 | 2 | S |
| | | | hydroxyalkyl | | | |
| | | | amide | | | |
| Example 3 | 3 | 28 | β- | 5 | 3 | B |
| | | | hydroxyalkyl | | | |
| | | | amide | | | |
| Example 4 | 4 | 28 | β- | 20 | 4 | S |
| | | | hydroxyalkyl | | | |
| | | | amide | | | |
| Example 5 | 5 | 28 | β- | 10 | 5 | A |
| | | | hydroxyalkyl | | | |
| | | | amide | | | |
| Example 6 | 6 | 28 | polyisocyanate | 10 | 6 | B |
| Comparative | 7 | 4 | β- | | 7 | C |
| Example 1 | | | hydroxyalkyl | | | |
| | | | amide | | | |
| Comparative | 8 | 28 | — | | 8 | C |
| Example 2 | | | | | | |

Aspects of the present disclosure are, for example, as follows.

### Aspect 1

A toner for a thermal transfer print sheet contains a polyester resin having an acid value of at least 25 mgKOH/g, a coloring pigment, a release agent, and a curing agent.

### Aspect 2

The toner according to Aspect 1 mentioned above, wherein the curing agent comprises β-hydroxyalkylamide.

### Aspect 3

A method of manufacturing a thermal transfer print sheet contains forming an image on a substrate with a toner containing a polyester resin having an acid value of at least 25 mgKOH/g, a coloring pigment, a release agent, and a curing agent.

### Aspect 4

The method according to Aspect 3 mentioned above, wherein the curing agent contains β-hydroxyalkylamide.

### Aspect 5

The method according to Aspect 3 or 4 mentioned above, wherein the forming includes forming a latent electrostatic image on a latent electrostatic image bearer, developing the latent electrostatic image formed on the latent electrostatic image bearer with the toner to form a toner image, transferring the toner image to the substrate, and fixing the toner image transferred onto the substrate.

### Aspect 6

A printing method includes forming an image on a substrate with a toner that contains a polyester resin having an acid value of at least 25 mgKOH/g, a coloring pigment, a release agent, and a curing agent, and thermally transferring the image to a transfer medium.

### Aspect 7

The printing method according to Aspect 6 mentioned above, wherein the transfer medium is ceramic.

### Aspect 8

A storage container for the toner of Aspect 1 or 2 mentioned above for a thermal transfer print sheet.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A toner for a thermal transfer print sheet comprising:
a polyester resin having an acid value of at least 25 mgKOH/g;
a coloring pigment;
a release agent; and
a curing agent.

2. The toner according to claim 1,
wherein the curing agent comprises β-hydroxyalkylamide.

3. A method of manufacturing a thermal transfer print sheet, comprising:
forming an image on a substrate with a toner comprising a polyester resin having an acid value of at least 25 mgKOH/g, a coloring pigment, a release agent, and a curing agent.

4. The method according to claim 3,
wherein the curing agent comprises β-hydroxyalkylamide.

5. The method according to claim 3,
wherein the forming comprising:
forming a latent electrostatic image on a latent electrostatic image bearer;
developing the latent electrostatic image formed on the latent electrostatic image bearer with the toner to form a toner image;
transferring the toner image to the substrate; and
fixing the toner image transferred onto the substrate.

6. A printing method comprising:
forming an image on a substrate with a toner comprising a polyester resin having an acid value of at least 25 mgKOH/g, a coloring pigment, a release agent, and a curing agent; and
thermally transferring the image to a transfer medium.

7. The printing method according to claim 6, wherein the substrate comprises ceramic.

8. A storage container for the toner of claim 1 for a thermal transfer print sheet.
